(19) United States
(12) Patent Application Publication
(10) Pub. No.: US 2005/0206152 A1
(43) Pub. Date: Sep. 22, 2005

(54) Vehicle occupant protection device having shoulder belt load limiters and an associated method

(75) Inventors: Neal H. Delventhal, Lake Orion, MI (US); Barry J. Maloney, Clinton Township, MI (US)

Correspondence Address: TAROLLI, SUNDHEIM, COVELL, & TUMMINO L.L.P., 1111 LEADER BLDG., 526 SUPERIOR AVENUE, CLEVELAND, OH, 44114-1400, US

(73) Assignee: TRW Vehicle Safety Systems Inc.

(21) Appl. No.: 10/804,728

(22) Filed: Mar. 19, 2004

(51) Int. Cl. B60R 22/28

(52) U.S. Cl. 280/805; 180/273; 180/274

(57) ABSTRACT

A vehicle occupant protection device (30) and a method of controlling the protection device (30) are provided. The protection device (30) includes first and second seat belts (36 and 38) and first and second load limiters (86 and 88) that are associated with the first and second seat belts (36 and 38), respectively. The protection device (30) also includes at least one sensor for sensing a characteristic of at least one of the occupant (18) and of the vehicle (14). The protection device (30) further includes a controller (260) that is responsive to the at least one sensor for controlling the first and second load limiters (86 and 88).

### TECHNICAL FIELD

The present invention relates to a vehicle occupant protection device for helping to protect an occupant of a vehicle and to a method for controlling the vehicle occupant protection device. More particularly, the present invention relates to a vehicle occupant protection device having load limiters associated with first and second shoulder belts and to a method for controlling the load limiters.

### BACKGROUND OF THE INVENTION

U.S. Pat. No. 6,076,894 discloses a seat belt system having two shoulder belts and two lap belts. Each shoulder belt extends from an associated shoulder belt retractor, which is fixed relative to an upper portion of a vehicle seat, downward to a buckle assembly. One lap belt extends upwardly from an anchor on the right side of the vehicle seat and through the buckle assembly. The lap belt then extends downwardly from the buckle assembly to a lap belt retractor. The other lap belt extends upwardly from an anchor on the left side of the vehicle seat and through the buckle assembly. The other lap belt then extends downwardly from the buckle assembly to the lap belt retractor.

It is known to use a load limiter in a seat belt retractor. A load limiter limits the load applied by the seat belt webbing to the occupant. A load limiter allows a limited amount of the seat belt webbing to be withdrawn from the seat belt retractor after the seat belt retractor has locked.

### SUMMARY OF THE INVENTION

The present invention relates to a vehicle occupant protection device for helping to protect an occupant of a seat of a vehicle. The vehicle occupant protection device comprises first and second seat belts and first and second load limiters associated with the first and second seat belts, respectively. At least one sensor of the vehicle occupant protection device senses a characteristic of at least one of the occupant and the vehicle. A controller is responsive to the sensor for controlling the first and second load limiters.

According to another aspect, the present invention relates to a method of controlling a vehicle occupant protection device associated with a seat of a vehicle. The vehicle occupant protection device has first and second seat belts and first and second load limiters that are associated with the first and second seat belts, respectively. The method comprises the steps of sensing a characteristic of at least one of an occupant of the seat and the vehicle; controlling the first load limiter in response to the sensed characteristic; and controlling the second load limiter in response to the sensed characteristic.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 is a schematic illustration of a vehicle occupant protection device constructed in accordance with the present invention;

FIG. 2 is a schematic cutaway of an exemplary retractor that includes a controllable load limiter having two levels of load limiting;

FIG. 3 schematically illustrates a portion of the load limiter of FIG. 2; and

FIG. 4 is a block diagram illustrating control portions the vehicle occupant protection device of FIG. 1.

### DETAILED DESCRIPTION OF THE INVENTION

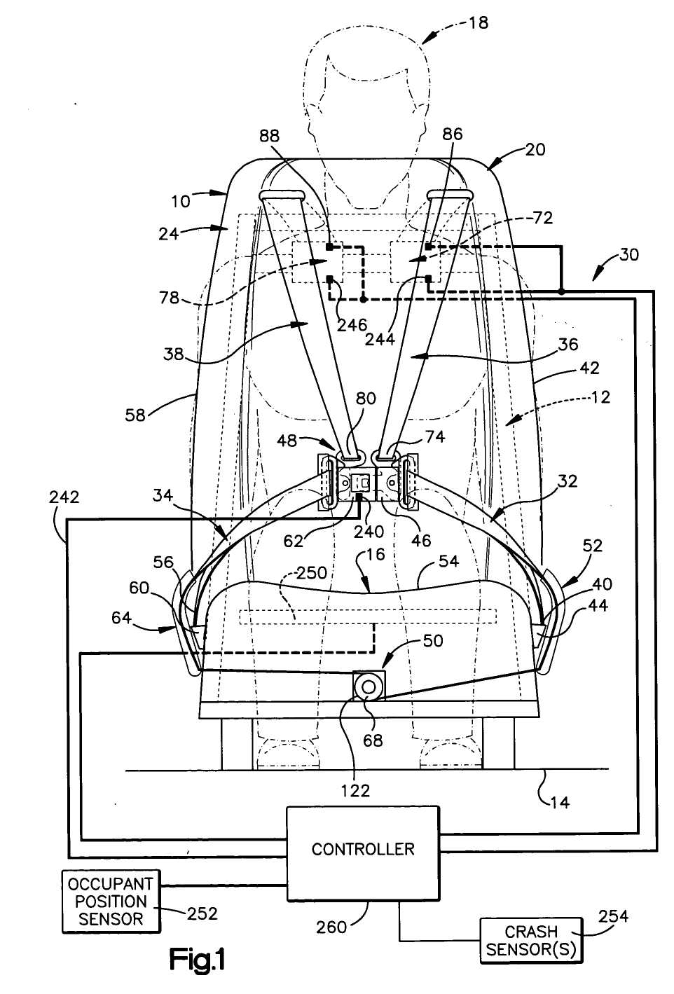

A vehicle seat 10 is shown in FIG. 1. The seat 10 includes a frame 12 that is secured to the vehicle 14 in a known manner. The seat 10 also includes a cushion portion 16 upon which a vehicle occupant 18 sits and a backrest portion 20 that extends upwardly from the cushion portion 16. An upper portion 24 of the backrest portion 20 of the seat 10 is located adjacent the shoulders of the seated occupant 18.

FIG. 1 also illustrates a vehicle occupant protection device 30 for helping to protect the occupant 18 of the seat 10. The vehicle occupant protection device 30 illustrated in FIG. 1 may be referred to as a “four-point seat belt system.” The vehicle occupant protection device 30 includes lap belts 32 and 34 and shoulder belts 36 and 38. Each lap belt 32 and 34 extends over a portion of the lap of the occupant 18 and each shoulder belt 36 and 38 extends over an associated shoulder of the occupant 18.

Lap belt 32 has an end 40 that is connected to the frame 12 on the left side 42 of the seat 10. An anchor 44 fixes end 40 to the frame 12. The anchor 44 may be attached to the frame 12 of the seat 10 in any suitable manner. The end 40 of the lap belt 32 is pivotal about the anchor 44 and relative to the seat 10. Lap belt 32 extends upwardly from anchor 44 and through a first portion 46 of a buckle assembly 48. Lap belt 32 then extends downwardly from the buckle assembly 48 to a lap belt retractor 50. An end (not shown) of lap belt 32 opposite end 40 is connected to the lap belt retractor 50. The lap belt retractor 50 is mounted to the frame 12 of the seat 10 within the cushion portion 16 of the seat.

A tubular lap belt guide 52 is attached to the frame 12 on the left side 42 of the seat 10. The tubular lap belt guide 52 guides the lap belt 32 from a location adjacent an upper surface 54 of the cushion portion 16 of the seat 10 to a location within the cushion portion as the lap belt extends toward the lap belt retractor 50.

Lap belt 34 is similar in construction to lap belt 32. Lap belt 34 has an end 56 that is connected to the frame 12 on the right side 58 of the seat 10. An anchor 60 fixes end 56 to the frame 12. The anchor 60 may be attached to the frame 12 of the seat 10 in any suitable manner. The end 56 of the lap belt 34 is pivotal about the anchor 60 and relative to the seat 10. Lap belt 34 extends upwardly from anchor 60 and through a second portion 62 of the buckle assembly 48. Lap belt 34 then extends downwardly from the buckle assembly 48 to the lap belt retractor 50. An end (not shown) of lap belt 34 opposite end 56 is connected to the lap belt retractor 50.

A tubular lap belt guide 64 is attached to the right side 58 of the seat 10. The tubular lap belt guide 64 guides the lap belt 34 from a location adjacent the upper surface 54 of the cushion portion 16 of the seat 10 to a location within the cushion portion as the lap belt extends toward the lap belt retractor 50.

The lap belt retractor 50 is a dual payout retractor and includes a single spool 68 for receiving both lap belts 32 and 34. As shown in FIG. 1, lap belt 32 extends from a lower side of the spool 68 and toward tubular lap belt guide 52. Lap belt 34 extends from an upper side of the spool 68 and toward tubular lap belt guide 64. Thus, rotation of the spool 68 in a clockwise direction, as viewed in FIG. 1, results in the retraction of both lap belts 32 and 34, and rotation of the spool 68 in a counterclockwise direction, as viewed in FIG. 1, is caused by the withdrawal of both lap belts 32 and 34. As an alternative to the dual payout lap belt retractor 50 illustrated in FIG. 1, the vehicle occupant protection system 30 may include separate first and second lap belt retractors that are associated with lap belts 32 and 34, respectively.

Alternatively, the vehicle occupant protection device 30 may include first and second lap belt retractors (not shown). Lap belt 32 may extend upwardly from the first lap belt retractor and may have an end that is attached to the buckle assembly 48. Similarly, lap belt 34 may extend upwardly from the second lap belt retractor, on a side of the seat 10 opposite the first lap belt retractor, and may include an end that is attached to the buckle assembly 48.

Shoulder belt 36 has a first end (not shown) that is connected with shoulder belt retractor 72 and a second end 74 that is connected to the first portion 46 of the buckle assembly 48. Shoulder belt retractor 72 is mounted to the frame 12 of the seat 10 in a location within the upper portion 24 of the backrest portion 20 and adjacent to the left side 42 of the seat. When the occupant 18 is seated in the seat 10, as shown in FIG. 1, shoulder belt 36 extends over a left shoulder of the occupant 18. The withdrawn length of shoulder belt 36 from shoulder belt retractor 72 is adjustable.

Shoulder belt 38 has a first end (not shown) that is connected with shoulder belt retractor 78 and a second end 80 that is connected to the second portion 62 of the buckle assembly 48. Shoulder belt retractor 78 is mounted to the frame 12 of the seat 10 in a location within the upper portion 24 of the backrest portion 20 and adjacent to the right side 58 of the seat. When an occupant 18 is seated in the seat 10, as shown in FIG. 1, shoulder belt 38 extends over a right shoulder of the occupant 18. The withdrawn length of shoulder belt 38 from shoulder belt retractor 78 also is adjustable.

Each of shoulder belt retractors 72 and 78 has an associated load limiter that is controllable for providing at least two different levels of load limiting. The load limiter that is associated with shoulder belt retractor 72 is shown schematically in FIG. 1 at 86. The load limiter that is associated with shoulder belt retractor 78 is shown schematically in FIG. 1 at 88.

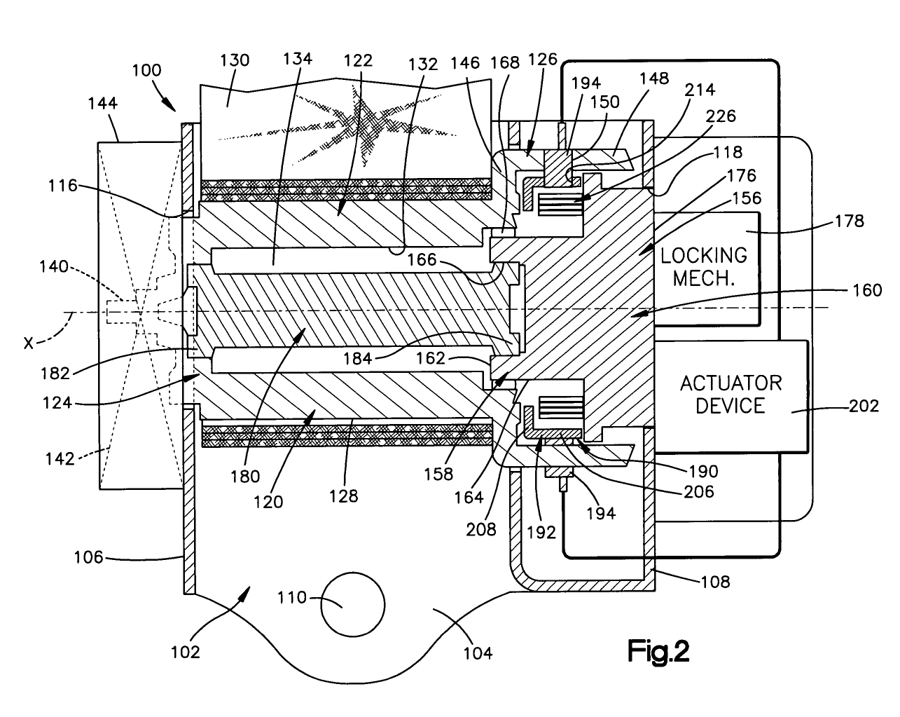

FIG. 2 is a schematic cutaway of an exemplary retractor 100 that includes a controllable load limiter having two levels of load limiting. Shoulder belt retractors 72 and 78 may have constructions similar to the retractor 100 of FIG. 2. Alternatively, shoulder belt retractors 72 and 78 may have any known retractor design that enables controllable load limiting at two or more levels.

The retractor 100 of FIG. 2 includes a frame 102 for mounting the retractor. The frame 102 includes a back wall 104 and opposite first and second side walls 106 and 108, respectively. The back wall 104 includes a mounting aperture 110 through which a fastener (not shown), such as a bolt, may extend. A first aperture 116 extends through the first side wall 106 of the frame 102. A second aperture 118 extends through the second side wall 108 of the frame 102. The first and second apertures 116 and 118 are coaxial with one another along axis X.

A spool 120 of the retractor 100 includes a tubular center portion 122 and opposite first and second end portions 124 and 126, respectively. The center portion 122 of the spool 120 includes a cylindrical outer surface 128 around which seat belt webbing 130 is wound. The center portion 122 also includes a cylindrical inner surface 132 that defines a central cavity 134 of the spool 120.

The first end portion 124 of the spool 120 extends through the first aperture 116 of the first side wall 106. The first end portion 124 narrows to a cylindrical rod 140 that is attached to a rewind spring 142 located in a housing 144 on a side of the first side wall 106 opposite the center portion 122 of the spool 120. The rewind spring 142 operates in a known manner to rotate the spool 120 in a retraction direction.

The second end portion 126 of the spool 120 is generally cup-shaped and includes a radial portion 146 and an axial portion 148. The radial portion 146 of the second end portion 126 extends radially outwardly, relative to axis X, of the center portion 122. The axial portion 148 of the spool 120 extends axially from the radial portion 146 in a direction opposite the center portion 122 of the spool. Two apertures 150, only one of which is shown in FIG. 2, extend radially through the axial portion 148 of the second end portion 126. The central cavity 134 of the spool 120 is open from the second end portion 126 of the spool.

The retractor 100 also includes a hub 156 that is received in the second end portion 126 of the spool 120. The hub 156 includes opposite first and second end portions 158 and 160, respectively. The first end portion 158 of the hub 156 is located nearest the center portion 122 of the spool 120. The first end portion 158 includes a first end surface 162 and a cylindrical outer surface 164. A recess 166 extends axially into the first end surface 162 of the first end portion 158 of the hub 156. A cylindrical bushing 168 spaces the cylindrical outer surface 164 of the first end portion 158 of the hub 156 from the spool 120.

The second end portion 160 of the hub 156 is generally cylindrical and extends through the second aperture 118 in the second side wall 108 of the frame 102. The second end portion 160 of the hub 156 terminates at a second end surface 176. The second end surface 176 includes structure (not shown), such as teeth, that is acted upon by a locking mechanism 178 of the retractor 100. The locking mechanism 178 is located on a side of the second side wall 108 opposite the spool 120. The locking mechanism 178 operates in a known manner to prevent rotation of the hub 156 relative to the frame 102.

A torsion bar 180 extends through the central cavity 134 of the spool 120 and connects the first end portion 124 of the spool to the first end portion 158 of the hub 156. A first end 182 of the torsion bar 180 is fixed relative to the first end portion 124 of the spool 120 and rotates with the first end portion 124. A second end 184 of the torsion bar 180 extends into the recess 166 in the first end surface 162 of the first end portion 158 of the hub 156 and is fixed to the first end portion 158. The second end 184 of the torsion bar 180 rotates with the first end portion 158 of the hub 156. The torsion bar 180 twists in response to a predetermined force rotating the spool 120 relative to the hub 156.

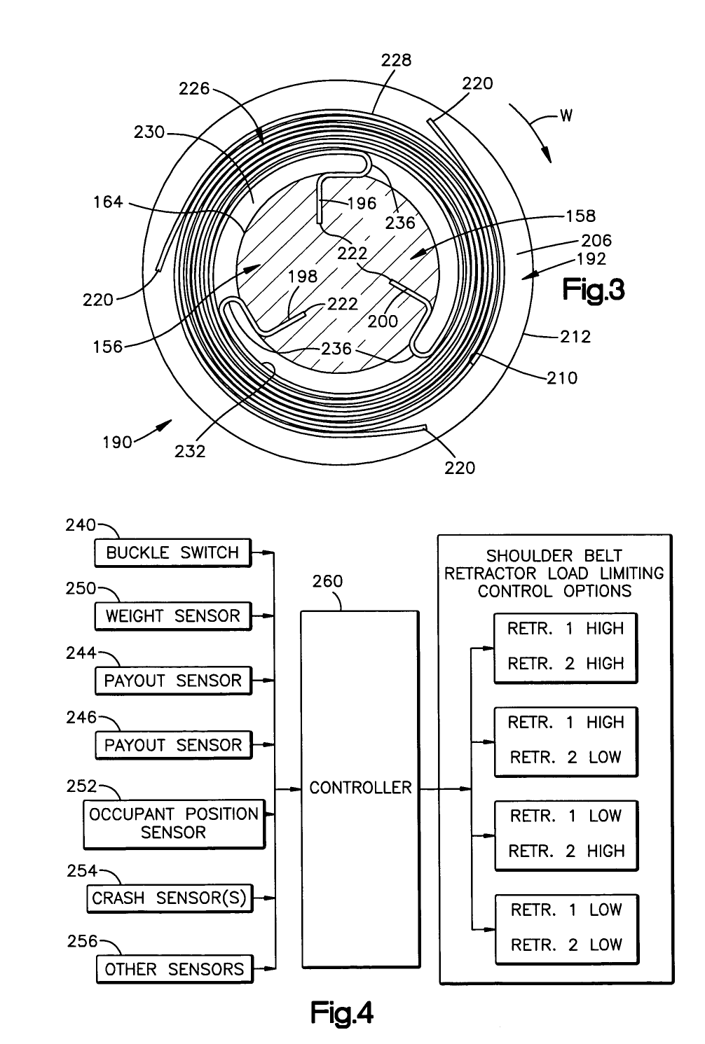

The retractor 100 also includes an energy converter device 190. FIG. 3 illustrates a portion of the energy converter device 190. The energy converter device 190 includes an outer ring 192, two locking pins 194 (FIG. 2), three metal strips 196, 198, and 200 (FIG. 3), the first end portion 158 of the hub 156, and an actuator device 202 (FIG. 2). As shown in FIG. 2, the outer ring 192 includes a tubular portion 206 and a radially inwardly extending flange 208. The tubular portion 206 includes inner and outer surfaces 210 and 212 (FIG. 3), respectively. Two apertures 214, only one of which is shown in FIG. 2, extend radially through the tubular portion 206 of the outer ring 192.

Each locking pin 194 has an associated aperture 214 in the tubular portion 206 of the outer ring 192. Each locking pin 194 extends through its associated aperture 214 in the tubular portion 206 of the outer ring 192. Each locking pin 194 also extends through an associated aperture 150 of the axial portion 148 of the second end portion 126 of the spool 120. The locking pins 194 connect the outer ring 192 to the spool 120 so that the outer ring rotates with the spool.

The actuator device 202 is operatively connected to both of the locking pins 194, as is shown schematically in FIG. 2. The actuator device 202 is controllable for removing the locking pins 194 from the apertures 214 of the outer ring 192. When removed from the apertures 214, the locking pins 194 remain in the apertures 150 of the spool 120. Removal of the locking pins 194 from the apertures 214 disconnects the outer ring 192 from the spool 120. In one embodiment of the invention, the actuator device 202 includes a piston (not shown) and a pyrotechnic actuator (not shown). The pyrotechnic actuator is actuated in response to receiving electronic actuation signals. Actuation of the pyrotechnic actuator causes movement of the piston. Movement of the piston results in the locking pins 194 being removed from the apertures 214 of the outer ring 192. The actuator device 202, however, may be any controllable device for removing the locking pins 194 from the apertures 214 of the outer ring 192, such as, for example, a solenoid.

As shown in FIG. 3, each of the three metal strips 196, 198, and 200 of the energy converter device 190 includes a first end 220 that is fixed to the outer ring 192 and a second end 222 that is fixed to the first end portion 158 of the hub 156. The three metal strips 196, 198, and 200 are wound together, in a clockwise direction as shown in FIG. 3, to form a tubular winding 226. An outer circumference 228 of the tubular winding 226 extends along the inner surface 210 of the outer ring 192. A space 230 separates an inner circumference 232 of the tubular winding 226 from the cylindrical outer surface 164 of the first end portion 158 of the hub 156. Each of the three metal strips 196, 198, and 200, at a location near its second end 222, is bent against the direction of the winding 226, i.e., in a counter-clockwise direction as viewed in FIG. 3. Thus, a bend 236 is formed in each of the three metal strips 196, 198, and 200 in a location near the second end 222. The bend 236 of each of the three metal strips 196, 198, and 200 extends through the space 230 so that the second end 222 may be attached to the first end portion 158 of the hub 156.

When the locking mechanism 178 prevents rotation of the hub 156 relative to the frame 102, a predetermined force acting to withdraw the seat belt webbing 130 from the retractor 100 will cause rotation of the spool 120 relative to the hub 156. Since the locking pins 194 of the energy converter device 190 connect the outer ring 192 to the spool 120, the outer ring 192 rotates with the spool 120 and relative to the hub 156. During withdrawal of the seat belt webbing 130 from the retractor 100, the outer ring 192 rotates in the clockwise direction indicated by arrow W in FIG. 3. As the outer ring 192 rotates relative to the hub 156, the tubular winding 226 is unwound from its location adjacent the inner surface 210 of the outer ring 192 and is wound around the cylindrical outer surface 164 of the first end portion 158 of the hub 156. During the movement of the tubular winding 226 to a location around the cylindrical outer surface 164 of the first end portion 158 of the hub 156, the bend 236 in each of the three metal strips 196, 198, and 200 is moved along the associated metal strip in a clockwise direction as viewed in FIG. 3. Bending resistances of the three metal strips 196, 198, and 200 resist this bending. Thus, the bending resistances of the three metal strips 196, 198, and 200 resist the rotation of the outer ring 192 and the spool 120, to which the outer ring is attached, relative to the hub 156.

The torsion bar 180 and the energy converter device 190 collectively form a load limiter that enables two different levels of load limiting. When the locking mechanism 178 is actuated to prevent rotation of the hub 156 relative to the frame 102, both the torsion bar 180 and the energy converter device 190 resist movement of the spool 120 relative to the hub 156. Thus, the torsion bar 180 and the energy converter device 190 operate in parallel to one another to resist rotation of the spool 120 relative to the hub 156. The torsion bar 180 and the energy converter device 190 operating in parallel to one another provides a high level of load limiting.

When the actuator device 202 is actuated and removes the locking pins 194 from the apertures 214 of the outer ring 192, the outer ring 192 no longer rotates with the spool 120. As a result, the energy converter device 190 is removed from resisting rotation of the spool 120 and no longer operates in parallel with the torsion bar 180. Instead, the torsion bar 180 acts alone for resisting rotation of the spool 120 relative to the hub 156. The torsion bar 180 acting alone provides a low level of load limiting. Since the low level of load limiting is performed by the torsion bar 180 alone and the high level is performed by the torsion bar 180 in parallel with the energy converter device 190, a greater amount of the seat belt webbing 130 is withdrawn from the spool 120 for a given load when the retractor 100 is providing the low level of load limiting than for that same load with the retractor providing the high level of load limiting.

With reference again to FIG. 1, the first portion 46 of the buckle assembly 48 includes a tongue assembly (not shown). The second portion 62 of the buckle assembly 48 includes a latch mechanism (not shown) for receiving the tongue assembly of the first portion 46. When the tongue assembly is received in the latch mechanism, the first portion 46 is latched to the second portion 62 and the buckle assembly 48 connects the lap belts 32 and 34 and the shoulder belts 36 and 38.

The buckle assembly 48 also includes a buckle switch 240. When the tongue assembly of the first portion 46 of the buckle assembly 48 is received in and latched by the latch mechanism of the second portion 62, the buckle switch 240 outputs an electronic signal indicating the latched condition of the buckle assembly 48. The electronic signal may be transferred through a wire, shown schematically at 242, that is preferably woven into shoulder belt 38 and is operatively connected to the buckle switch 240. Alternatively, the electronic signal may be transferred by wireless communication such as a radio frequency signal.

The vehicle occupant protection device 30 also includes payout sensors 244 and 246. The payout sensor 244 is associated with shoulder belt retractor 72. The payout sensor 244 senses the payout, i.e., the withdrawn length, of shoulder belt 36 and outputs a signal indicative of the sensed payout. The payout sensor 246 is associated with shoulder belt retractor 78. The payout sensor 246 senses the payout, i.e., the withdrawn length, of shoulder belt 38 and outputs a signal indicative of the sensed payout.

The vehicle occupant protection device 30 also includes an occupant weight sensor 250. The occupant weight sensor 250 senses the weight of an object positioned on the upper surface 54 of the cushion portion 16 of the seat 10 and outputs an electrical signal indicative of the sensed weight. The occupant weight sensor 250 may also sense the distribution of the weight applied to the upper surface 54 of the cushion portion 16 of the seat 10 and the electrical signal, in addition to indicating the sensed weight, may also indicate the sensed distribution of the weight. The sensed weight may be indicative of a classification of the occupant 18. Occupant classifications may include, but are not limited to, adult, child, rearward facing child seat, and forward facing child seat. The sensed distribution of the weight may be indicative of a position of the occupant 18 relative to the seat 10. For example, when a majority of the weight is applied to a front portion of the cushion portion 16 of the seat 10, the weight distribution may indicate that the occupant 18 of the seat 10 is leaning forward.

The vehicle occupant protection device 30 may also include an occupant position sensor 252. The occupant position sensor 252 may be used in conjunction with or as an alternative to the occupant weight sensor 250. The occupant position sensor 252 is operative for determining the position of the occupant 18 relative to the seat 10. The occupant position sensor 252 may include an ultrasonic sensor. Alternatively, the occupant position sensor 252 may include a camera and pattern recognition software for determining the position of the occupant 18 relative to the seat 10 and also for classifying the occupant 18. As stated above, occupant classifications may include, but are not limited to, adult, child, rearward facing child seat, and forward facing child seat. The occupant position sensor 252 outputs electronic signals indicative of the sensed occupant position and/or classification.

The vehicle occupant protection device 30 also includes one or more crash sensors 254. Each of the crash sensors 254 senses a vehicle condition indicating the occurrence of a crash condition and outputs an electronic signal indicative of the crash condition. In an exemplary embodiment of the invention, the crash sensors 254 indicate both the severity and the direction of a vehicle impact.

Other sensors 256 may also be included in the vehicle occupant protection device 30. The other sensors 256 may include, for example, an impending crash sensor for the vehicle 14, such as a forward-looking radar device, or any other sensor for sensing a characteristic of the vehicle 14 or the occupant 18. It is noted that characteristics of the vehicle 14 includes characteristics of the vehicle occupant protection system 30 of the vehicle.

As is shown in FIG. 4, a controller 260 of the vehicle occupant protection system 30 is operatively connected to and receives signals from the buckle switch 240, the payout sensors 244 and 246, the weight sensor 250, the occupant position sensor 252, the crash sensors 254, and the other sensors 256. The controller 260 is preferably a microcomputer that receives power from a power source (not shown), such as the battery of the vehicle 14.

The controller 260 is also operatively connected to the load limiters 86 and 88 of the shoulder belt retractors 72 and 78, respectively. FIG. 4 illustrates load limiting options for the load limiters 86 and 88 of the shoulder belt retractors 72 and 78, respectively, when the load limiter of each shoulder belt retractor is capable of providing a low level and a high level of load limiting. In FIG. 4, RETR. 1 indicates shoulder belt retractor 72, which includes load limiter 86, and RETR. 2 indicates shoulder belt retractor 78, which includes load limiter 88. The controller 260 is responsive to the signals from at least one of the buckle switch 240, the payout sensors 244 and 246, the weight sensor 250, the occupant position sensor 252, the crash sensors 254, and the other sensors 256 for determining desired load levels for the shoulder belts 36 and 38 and for selecting a load limiting option for the load limiters 86 and 88 so as to provide the desired load levels.

By way of example, assume that each of the load limiters 86 and 88 has two levels of load limiting and that the two levels include a low level at 1.5 kilo-newtons and a high level at 3.2 kilo-newtons. The controller 260 may control the load limiters 86 and 88 so as to provide load limiting combinations of 3 kilo-newtons, 4.7 kilo-newtons, and 6.4 kilo-newtons. Also, the controller 260 may control the load limiters 86 and 88 so as to provide directional load limiting. For example, when both load limiters 86 and 88 are controlled to be at the low level and when both load limiters are controlled to be at the high level, the load limiting of the vehicle occupant protection system 30 is symmetrical. When one load limiter is controlled to be at the low level and the other load limiter is controlled to be at the high level, however, the load limiting is directional and enables more movement of the torso of the occupant 18 in one direction than in the other direction.

Some specific examples illustrating the control of the load limiters 86 and 88 of the shoulder belt retractors 72 and 78, respectively, are given below. These examples are for exemplary purposes and are not meant to be limiting.

In a first example, the buckle switch 240 indicates that the buckle assembly 48 is latched and the weight sensor 250 and the position sensor 252 both indicate that the occupant 18 is an adult driver of the vehicle 14 who is properly seated on the seat 10. The payout sensors 244 and 246 indicate equal payouts of shoulder belts 36 and 38. When the crash sensors 254 indicate a vehicle rollover condition, the controller 260 may control the load limiters 86 and 88 of the shoulder belt retractors 72 and 78 to provide a high level of load limiting with both load limiters. This control of the load limiters 86 and 88 helps to hold the occupant 18 against movement relative to the seat 10 during the vehicle rollover.

In a second example, the buckle switch 240 indicates that the buckle assembly 48 is latched and the weight sensor 250 and the position sensor 252 both indicate that the occupant 18 is an adult driver of the vehicle 14 who is properly seated on the seat 10. The payout sensors 244 and 246 indicate equal payouts of shoulder belts 36 and 38. The equal payouts of the shoulder belts 36 and 38 are indicative of the buckle assembly 48 being centered relative to a properly seated occupant 18. When the crash sensors 254 indicate an impact on the passenger side of the vehicle 14, the controller 260 may control the load limiters 86 and 88 of shoulder belt retractors 72 and 78, respectively, to provide a low level of load limiting with both load limiters. The low level of load limiting allows a greater amount of shoulder belts 36 and 38 to be withdrawn from shoulder belt retractors 72 and 78, respectively, as compared to when each of the load limiters 86 and 88 provides a high level of load limiting. The control of the load limiters 86 and 88, in this example, to provide a low level of load limiting enables the torso of the occupant 18 to move toward the passenger side of the vehicle 14 and reduces the load applied to the neck of the occupant. It is noted that if the occupant's torso is fixed relative to the seat 10 during the this crash condition, the occupant's head will tend to move toward the passenger side of the vehicle 14 applying a load to the occupant's neck.

In a third example, the buckle switch 240 indicates that the buckle assembly 48 is latched and the weight sensor 250 and the position sensor 252 both indicate that the occupant 18 is an adult driver of the vehicle 14 who is properly seated on the seat 10. The payout sensors 244 and 246 indicate equal payouts of shoulder belts 36 and 38. When the crash sensors 254 indicate a frontal impact that is offset toward the passenger side of the vehicle 14 (at an angle from the passenger's side toward the driver's side), the controller 260 may control the load limiter 86 of shoulder belt retractor 72 (the shoulder belt retractor nearest the driver's side of the vehicle 14) to provide a low level of load limiting and control the load limiter 88 of shoulder belt retractor 78 (the shoulder belt retractor nearest the passenger's side of the vehicle 14) to provide a high level of load limiting. This control of the load limiters 86 and 88 enables the torso of the occupant 18 to move slightly toward the direction of the impact, i.e., twist so as to face the direction of impact, while preventing the occupant 18 from twisting out of shoulder belt 38 (the shoulder belt nearest the passenger's side of the vehicle 14).

The vehicle occupant protection device 30 of the present invention enables the load limiting characteristics of the load limiters 86 and 88 of the shoulder belt retractors 72 and 78, respectively, to be varied in response to various sensed occupant characteristics and sensed vehicle characteristics. As a result, and as illustrated in the above examples, the load limiting characteristics of the vehicle occupant protection system 30 may be tailored to the particular occupant 18 and/or the particular vehicle crash condition.

From the above description of the invention, those skilled in the art will perceive improvements, changes and modifications. Such improvements, changes and modifications within the skill of the art are intended to be covered by the appended claims.

1. A vehicle occupant protection device for helping to protect an occupant of a seat of a vehicle, the vehicle occupant protection device comprising:
first and second seat belts;
first and second load limiters associated with the first and second seat belts, respectively;
at least one sensor for sensing a characteristic of at least one of the occupant and the vehicle; and
a controller that is responsive to the at least one sensor for controlling the first and second load limiters.

2. The vehicle occupant protection device of claim 1 wherein each of the first and second load limiters is controllable for providing first and second levels of load limiting, the controller being responsive to the at least one sensor for controlling the level of load limiting of the first and second load limiters.

3. The vehicle occupant protection device of claim 2 wherein the first seat belt is a first shoulder belt and the first load limiter forms a part of a first shoulder belt retractor and wherein the second seat belt is a second shoulder belt and the second load limiter forms a part of a second shoulder belt retractor.

4. The vehicle occupant protection device of claim 2 wherein the at least one sensor includes at least one vehicle crash sensor for sensing a vehicle condition indicating the occurrence of a crash condition and for providing a vehicle crash signal to the controller, the controller being responsive to vehicle crash signal for controlling the levels of the first and second load limiters.

5. The vehicle occupant protection device of claim 4 wherein the at least one vehicle crash sensor is adapted to sense both a severity and a direction of a vehicle impact and the vehicle crash signal indicates both the severity and the direction, the controller being responsive to both the severity and the direction of the vehicle impact for controlling the levels of the first and second load limiters.

6. The vehicle occupant protection device of claim 2 wherein the at least one sensor includes a weight sensor for sensing a weight of the occupant and providing a weight signal indicative of the sensed weight, the controller being responsive to sensed weight for controlling the levels of the first and second load limiters.

7. The vehicle occupant protection device of claim 6 wherein the weight sensor is operative for sensing a distribution of weight on the seat and the weight signal also indicates the sensed distribution, the controller being responsive to the sensed distribution for controlling the levels of the first and second load limiters.

8. The vehicle occupant protection device of claim 2 wherein the at least one sensor includes a first payout sensor associated with the first seat belt for sensing a withdrawn length of the first seat belt and providing a first payout signal indicative of the sensed withdrawn length, the vehicle occupant protection device further including a second payout sensor associated with the second seat belt for sensing a withdrawn length of the second seat belt and providing a second payout signal indicative of the sensed withdrawn length, the controller being responsive the first and second payout signals for controlling the levels of the first and second load limiters.

9. The vehicle occupant protection device of claim 2 wherein the at least one sensor includes an occupant position sensor for sensing a position of the occupant relative to the seat and for providing a position signal indicative of the sensed position, the controller being responsive to the position signal for controlling the levels of the first and second load limiters.

10. The vehicle occupant protection device of claim 2 wherein the at least one sensor is adapted to provide a signal indicative of a classification of the occupant of the seat, the controller being responsive to the classification of the occupant for controlling the levels of the first and second load limiters.

11. A method of controlling a vehicle occupant protection device associated with a seat of a vehicle, the vehicle occupant protection device having first and second seat belts and first and second load limiters that are associated with the first and second seat belts, respectively, the method comprising the steps of:
sensing a characteristic of at least one of an occupant of the seat and the vehicle;
controlling the first load limiter in response to the sensed characteristic; and
controlling the second load limiter in response to the sensed characteristic.

12. The method of claim 11 wherein each of the first and second load limiters is controllable for providing first and second levels of load limiting and wherein the step of controlling the first load limiter in response to the sensed characteristic further includes the step of controlling the level of load limiting of the first load limiter and wherein the step of controlling the second load limiter in response to the sensed characteristic further includes the step of controlling the level of load limiting of the second load limiter.

13. The method of claim 12 wherein the first seat belt is a first shoulder belt and the second seat belt is a second shoulder belt and wherein the step of controlling the level of load limiting of the first load limiter includes the step of determining a desired load limiting level for the first shoulder belt and wherein the step of controlling the level of load limiting of the second load limiter includes the step of determining a desired load limiting level for the second shoulder belt.

14. The method of claim 12 wherein the step of sensing a characteristic of at least one of an occupant of the seat and the vehicle includes the step of sensing both a severity and a direction of a vehicle impact.

15. The method of claim 12 wherein step of sensing a characteristic of at least one of an occupant of the seat and the vehicle includes the step of sensing a weight of the occupant.

16. The method of claim 15 wherein the step of sensing a weight of the occupant further includes the step of sensing a distribution of weight on the seat.

17. The method of claim 12 wherein the step of sensing a characteristic of at least one of an occupant of the seat and the vehicle includes the steps of sensing a withdrawn length of the first seat belt and sensing a withdrawn length of the second seat belt.

18. The method of claim 12 wherein the step of sensing a characteristic of at least one of an occupant of the seat and the vehicle includes the step of sensing a position of the occupant relative to the seat.

19. The method of claim 12 wherein the step of sensing a characteristic of at least one of an occupant of the seat and the vehicle further includes the step of determining a classification of the occupant of the seat.
